(19) United States
(12) Patent Application Publication
(10) Pub. No.: US 2007/0258122 A1
(43) Pub. Date: Nov. 8, 2007

(54) Computer-Tomography Microscope and Computer-Tomography Image Reconstruction Methods

(75) Inventors: Ravil O. Chamgoulov, Burnaby (CA); Pierre M. Lane, Vancouver (CA); Michael Tsiroulnikov, Richmond (CA); Calum E. Macaulay, Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: BC CANCER AGENCY, Vancouver, BC (CA)

(21) Appl. No.: 11/576,816

(22) PCT Filed: Oct. 5, 2005
(86) PCT No.: PCT/CA05/01522

§ 371 Date: Apr. 6, 2007

Related U.S. Application Data
(60) Provisional application No. 60/615,945, filed on Oct. 6, 2004.

(51) Int. Cl. G02B 26/08; G06F 19/00

(52) U.S. Cl. 359/225; 702/1

(57) ABSTRACT

An optical computed-tomography microscope for three-dimensional (3-D) imaging employs tomographic reconstruction for image acquisition. The microscope has an optical scanner to vary an angle at which a light beam passes through a specimen. A method for limited-angle computed-tomography reconstruction applies a transform to produce an image from a number of projections. The image is iteratively feedback-corrected.

### REFERENCE TO RELATED APPLICATION

This application claims priority from U.S. Application No. 60/615,945 filed 6 Oct. 2004. For purposes of the United States, this application claims the benefit under 35 U.S.C. §119 of U.S. Application No. 60/615,945 filed 6 Oct. 2004, which is hereby incorporated herein by reference.

### TECHNICAL FIELD

The invention relates to three-dimensional imaging using computed-tomography.

### BACKGROUND—OPTICAL COMPUTED—TOMOGRAPHY MICROSCOPES

Optical computed-tomography microscopy can be used to obtain two-dimensional (2-D) or three-dimensional (3-D) images of specimens such as absorption-stained fixed pathological material. An optical computed-tomography microscope transmits beams of light through a specimen at different angles. Projections of the specimen are recorded at the different angles. The projections are processed using tomographic computations to reconstruct the spatial distribution of the linear attenuation coefficient within the specimen.

Each element in each recorded projection corresponds to a line integral of the attenuation coefficient along the beam path. The line integral represents a total attenuation of the beam as it goes along a straight line through the specimen. A 3-D distribution of the attenuation coefficient provides information about the 3-D structure of the specimen.

Tomographic techniques are well established in the context of 3-D X-ray imaging as a means for determining 3-D absorption profiles. Tomography techniques have also been applied, for instance, in X-ray phase contrast tomography and X-ray micro-tomography.

Relatively little attention has been given to applying computed tomography in the context of optical microscopy. The idea of tomographic optical microscopy using a computerized reconstruction algorithm and a transmission optical microscope was proposed in S. Kawata et al., Optical Microscopic Tomography, Proc. SPIE vol. 558, pp. 15-20, 1985. That paper discloses a straight implementation of X-ray computed-tomography (CT) technique in an optical microscope. An off-axis pinhole in the microscope was used to project a 3-D absorbance distribution of the specimen in various directions. The off-axis pinhole was rotated about the optical axis in the plane of a condenser stop. This system suffered from a weak intensity of illumination.

The system was subsequently improved to provide better illumination by providing a He—Ne laser as a light source and using a Pechan prism for shifting the location of the exit light beam. The stage supporting the prism could be rotated around the optical axis of the microscope by a motor, providing rotational illumination. This work is described in the following papers: C. Yang, et al. Phase-Dispersion Optical Tomography, Optics Letters, vol. 26, Issue 10, pp. 686-688, 2001; S. J. Pan, et al., Experimental System for X-Ray Cone-Beam Microtomography, Microscopy Microanalysis, No. 4, pp. 56-62, 1998; and, G. Wang et al., Scanning Cone-Beam Reconstruction Algorithms for X-Ray Microtomography, Proc. SPIE, vol. 1556, pp. 99-112, 1999.

MacAulay, U.S. Pat. No. 6,483,641, discloses an imaging system that includes a spatial light modulator comprising an array of individual light transmission pixels that can selectively modulate light. The spatial light modulator is located on the conjugate image plane of the aperture diaphragm of an objective lens. By selectively turning on pixels in different areas of the spatial light modulator it is possible to generate beams of light incident on a specimen from different angles. The system can be used to acquire projections for use in computed-tomography microscopy. Providing a computer-controlled spatial light modulator, such as a DMD, in the pupil plane of the condenser for illumination offers significant advantages in flexibility and precision over the mechanical system described above.

A digital spatial light modulator in a computed-tomography microscope enables the sequential illumination of a specimen with light incident at a selected set of illumination angles in any arbitrary sequence.

R. Chamgoulov et al., Optical computed-tomography microscope using digital spatial light modulation, in Three-Dimensional and Multi-Dimensional Microscopy: Image Acquisition and Processing XI, Proc. of SPIE, vol. 5324, pp. 182-190, 2004 discloses a computed tomography microscope system which uses a digital micro-mirror device (“DMD”) as a spatial light modulator to control the angle at which a light beam illuminates a specimen. 3-D grayscale images of absorption-stained cells having resolution sufficient to see the inner cellular structure were generated using this system.

The inventors have identified various limitations of DMD-based optical computed-tomography microscopes. The overall optical efficiency of such microscopes is low because only small numbers of micro-mirrors (those defining a small moving aperture) are in the ‘on’ position at any one time. Light which falls on micro-mirrors that are “off” is wasted. Secondly, the angular view of the system is limited because the movable aperture has a significant diameter. If the aperture moves over the edge of the pupil, the efficiency with which light passes to the specimen is reduced. Further, a DMD introduces a chromatic aberration, which causes the field of illumination to shift with wavelength. This effect, which arises because the DMD acts as a diffraction grating, prevents obtaining true color 3-D images.

### BACKGROUND—COMPUTED TOMOGRAPHY METHODS

Computed tomography (CT), as a technique for reconstruction of two-dimensional (2-D) and three-dimensional (3-D) images from projections is widely used in medicine, physical science, and industry. Reconstruction algorithms have been developed for various applications.

Conventional computed tomography methods employ a collection of measured projections that are evenly distributed over 360 degrees. Even where such projections are obtained, the initial data are discrete and are sub-sampled as a result. For reconstruction of objects that are transparent at the specific wavelength(s) for which projections are acquired, projections taken over 180 degrees give a complete angular initial data set.

Computed-tomography reconstruction algorithms can be divided into two main groups based on the mathematical approach for image reconstruction:
Transform-based algorithms;
Iterative algorithms;
   Each group of reconstruction algorithms has advantages and disadvantages relative to the other for solving specific problems.

Iterative reconstruction algorithms can be subdivided into two main groups: algebraic reconstruction algorithms and statistical algorithms. Statistical algorithms for image reconstruction seek a solution that best matches the probabilistic behavior of the data. For instance, maximum-likelihood (ML) estimation selects the reconstruction, which most closely matches the available data. P. E. Kinahan, et al. Statistical image reconstruction in PET with compensation for missing data, IEEE Trans. on Nuclear Science, vol. 44, No. 4, 1997, pp. 1552-1557 describes a statistical reconstruction algorithm.

Algebraic algorithms solve systems of linear equations. Some algebraic algorithms apply a recursive approach. S. Kaczmarz, Angenäherte Auflösung von Systemen hnearer Gleichungen, Bull. Int. Acad. Pol. Sci. Lett., A 35, 1937, pp. 335-357 is an example. Some algebraic algorithms apply conjugate gradients. For example, see W. H. Press et al. Numerical Recipes in C, chapter 10, Minimization or Maximization of Functions, pp. 463-469. Cambridge University Press, 2nd edition, 1992.

There are several problems associated with iterative algorithms. Such algorithms are computationally intensive. It can be a problem to solve a given system of linear equations with a reasonable number of iterations. Some advantages of iterative methods include accurate image reconstruction and, possibly, the ability to incorporate prior knowledge about the specimen, including geometry, background information and so forth.

The Radon transformation (see A. C. Kak, et al., Principles of Computerized Tomographic Imaging, Society of Industrial and Applied Mathematics, 2001) provides a convenient approach to tomographic image reconstruction. The Radon transformation defines mathematically the projection operator of a function. The transform-based standard filtered back-projection algorithm (FBP) that combines information from different angular positions can calculate 3-D (or 2-D) distributions of the attenuation coefficient. Since the attenuation coefficient is directly proportional to a density for a given material, the technique effectively allows determination of the 3-D density distribution within a specimen. The FBP algorithm is currently used in many applications of straight ray tomography. It has been shown to be very accurate for complete data reconstruction.

Many other algorithms that involve the representation of images in a frequency domain can also be used in computed-tomography applications. An example is Hartley transformation (see A. B. Watson et al., Separable two-dimensional discrete Hartley transform, J. Opt. Soc. Am., A 3, 1986, pp. 2001-2004). The Hartley transformation is another Fourier-related transformation that transforms real inputs to real outputs with no involvement of complex numbers. However, direct implementation of transform-based algorithms where projections are available for only a limited range of angles does not provide reconstructed images having accuracy acceptable for some applications.

B. P. Medoff, et al. Iterative convolution backprojection algorithms for image reconstruction from limited data, J. Opt. Soc. Am. 73(11), 1983, pp. 1493-1500; and, M. Nassi, et al., Iterative reconstruction-reprojection: an algorithm for limited data cardiac-computed tomography, IEEE Trans. Biomed. Eng., vol. BME-29, No. 5, 1982, pp. 333-341 describe reconstruction algorithms based on the Hartley transform that use an iterative procedure in transform-based image reconstruction. These algorithms attempt to improve reconstructed image quality iteratively by using estimates of missing line-integral data. These algorithms involve setting known transform values in a frequency domain and constraints known a priori in the space domain at each iteration in order to define, as well as possible, the extent of the object from missing data within the reconstruction space.

The limited angular view in the optical computed-tomography microscopes described above is a major problem for traditional reconstruction techniques. It leads to the presence of artifacts in the reconstructed images.

There is a need for microscopy systems that can provide high quality images. There is also a need for computed-tomography methods for reconstructing images of specimens, especially in cases where the information on which the reconstruction is to be based is limited.

### SUMMARY

This invention provides systems and apparatus for computed-tomography. One aspect of the invention provides microscopes configured to acquire projections for computed tomography imaging. Another aspect of the invention provides computational methods and apparatus for generating 2-D or 3-D images from a plurality of projections.

A computed-tomography microscope according to one aspect of the invention comprises: a light source; a condenser lens having a pupil plane; an optical system arranged to focus light from the light source at a focal point on the pupil plane of the condenser lens, the optical system comprising an optical scanner operable to move a location of the focal point on the pupil plane; an objective lens located to collect light incident from the condenser lens and deliver the collected light to an array of light detectors; and, a support for holding a specimen between the condenser lens and the objective lens.

A computed-tomography microscope according to another embodiment of the invention comprises a light source; a condenser lens having a pupil plane; an objective lens located to collect light incident from the condenser lens and deliver the collected light to a light sensor; a support for holding a specimen between the condenser lens and the objective lens; and an optical system comprising an optical scanner operable to cause light passing through the specimen at an angle corresponding to a setting of the optical scanner to be selectively detected at the light sensor. The optical scanner may be provided on either an illumination side or a detection side of the specimen. Some embodiments provide optical scanners on both the illumination side and detection side of the specimen.

A method for generating images of specimens according to another aspect of the invention comprises: for each of a plurality of angles, obtaining an initial projection of the specimen; applying a transform to the initial projections to yield a reconstructed image of the specimen; and refining the reconstructed image of the specimen. Refining the reconstructed image of the specimen comprises: for each of the plurality of angles computing a computed projection of the reconstructed image and computing a difference between the computed projection and the corresponding initial projection; applying the transform to the computed differences to yield an error image; and, combining the error image with the reconstructed image. Refining the reconstructed image of the specimen may be iterated.

Further aspects of the invention and features of embodiments of the invention are described below.

### BRIEF DESCRIPTION OF THE DRAWINGS

Exemplary embodiments are illustrated in the appended drawings. The embodiments disclosed and shown herein are intended to be illustrative and not restrictive. In the appended drawings:

FIG. 1 is a schematic illustration showing a prior-art DMD-based optical computed-tomography microscope;

FIG. 2A is a schematic view of an optical-scanner-based computed-tomography microscope having a collimated light source and an illumination-side optical scanner;

FIG. 2B is a schematic view of an optical-scanner-based computed-tomography microscope having a collimated light source and both illumination-side and detection-side optical scanners;

FIG. 2C is a schematic view of an optical-scanner-based computed-tomography microscope having a collimated light source and an detection-side optical scanner;

FIGS. 3A, 3B and 3C are schematic views of various angle-selective detection-side optical systems;

FIG. 4 is a schematic illustration showing an optical-scanner-based computed-tomography microscope with three collimated light sources for color 3-D imaging;

FIG. 5 is a flow diagram illustrating a reconstruction method according to the invention;

FIG. 6 is a plot illustrating normalized projection error versus the number of iterations for 120-degree reconstructions with different values for a feedback gain parameter;

FIG. 7A shows projection error calculated for limited-angle (120 degrees) reconstruction by standard FBP algorithm;

FIG. 7B shows the projection error after the 20th iteration of a reconstruction method according to the invention;

FIG. 8 is a plot illustrating normalized projection error versus the number of iterations using the method of FIG. 4;

FIG. 9 is a plot illustrating normalized projection error for the limited-angle reconstruction (120-degrees) with different numbers of initial projections (200, 100, 50, 40, and 30 projections);

FIG. 10 shows reconstruction results for different limited angles (160 to 80 degrees); and,

FIG. 11 is a schematic view of a confocal microscope according to an embodiment of the invention.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

Prior Art

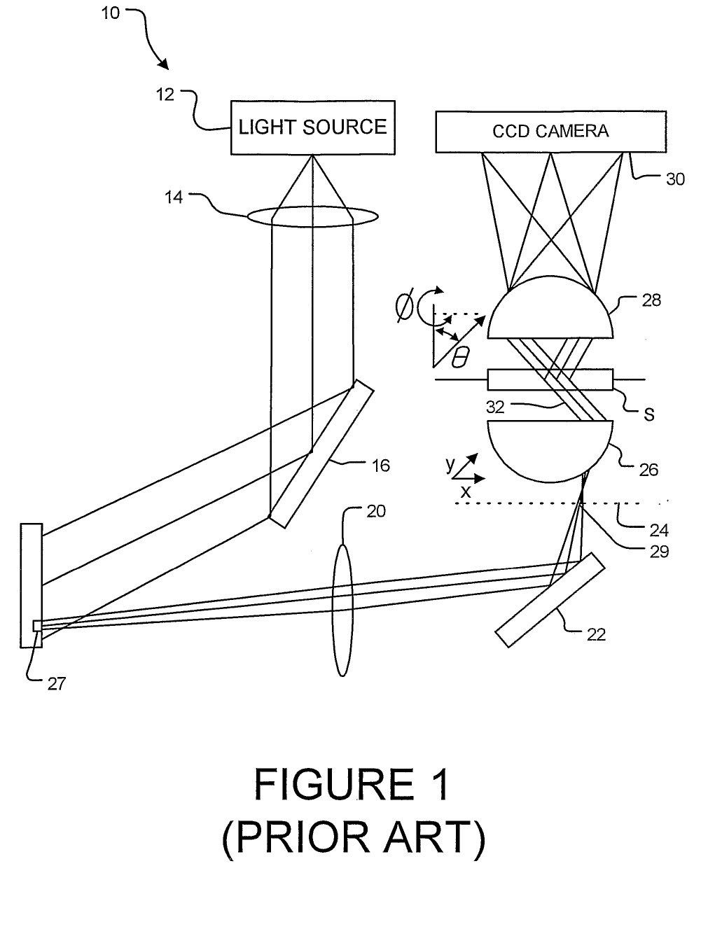

FIG. 1 shows a prior art DMD-based optical computed-tomography microscope 10. Microscope 10 has a light source 12. Light from source 12 is collimated by lens 14 and directed by mirror 16 onto DMD 18. Light from DMD 18 is focused by relay lens 20 and mirror 22 onto the back pupil plane 24 of a condenser lens 26. DMD 18 is located conjugate to the back pupil plane 24 of condenser lens 26.

Light passes from condenser lens 26 through a specimen S to an objective lens 28. Objective lens 28 delivers the light to a CCD camera 30.

The DMD is an array of tiny micromirrors, each of which can be controlled individually. A group of micromirrors can be turned on to create a spot of light that is imaged on the pupil plane of condenser lens 26. In the illustrated embodiment, mirrors in area 27 of DMD 18 are turned on to yield a spot 29 in pupil plane 24. The position (x, y) of the spot is determined by the location on DMD 18 of the group of micromirrors that is turned on. Each position (x, y) causes the specimen to be illuminated by a light beam 32 at a specific angle (φ, θ).

The specimen can be illuminated from different angles by turning on groups of micro-mirrors in different locations on DMD 18. For each angle, CCD camera 30 can acquire an image (projection). Projections from several angles can be used to reconstruct a 3-D image of the specimen.

This Invention

An optical computed-tomography microscope can employ an optical scanner to obtain projections corresponding to light beams directed through a specimen at different angles. The projections may be processed in a suitable computed-tomography method to yield a reconstructed image of the specimen. An optical scanner may be provided on the illumination side of a specimen, on the detection side of a specimen or both on the illumination and detection sides of a specimen.

The optical scanner may be located:
in a plane conjugate to the field plane,
in a plane conjugate to the aperture stop, or
at other suitable locations along the optical path of the microscope.

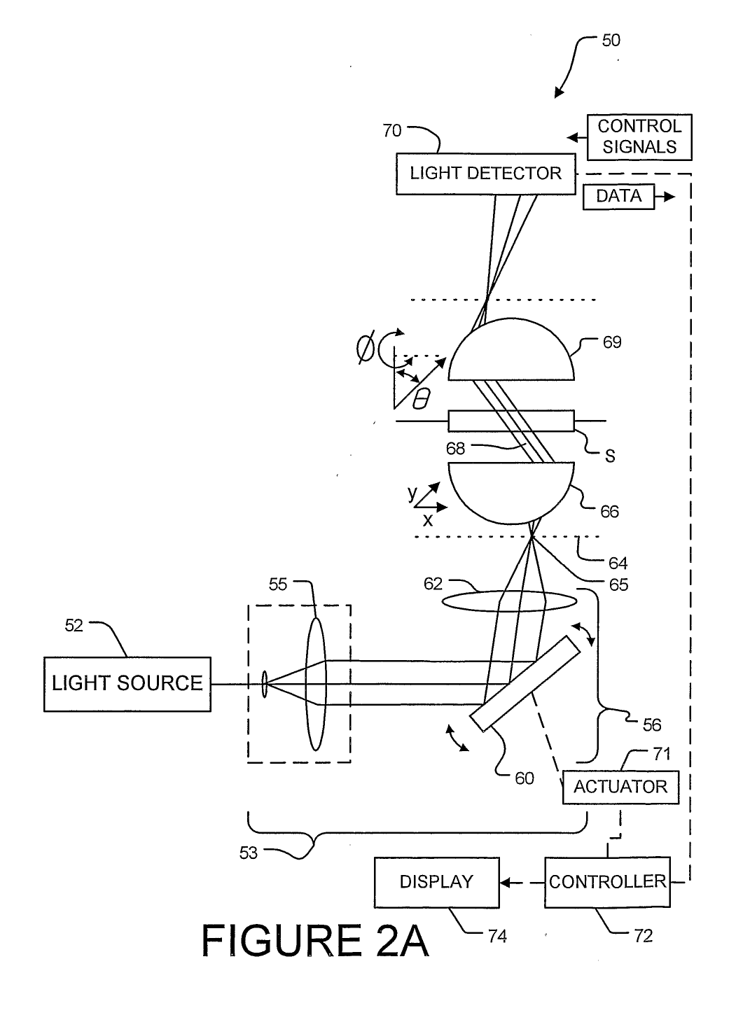

FIG. 2A is a schematic illustration of a microscope 50 according to an example embodiment of the invention in which an optical scanner 60 is provided on an illumination side of a specimen S.

Microscope 50 has a light source 52. An optical system 53 is arranged to focus light from light source 52 at a focal point 65 on the pupil plane 64 of a condenser lens 66. In the illustrated embodiment, light from light source 52 passes through a beam expander 55 to a deflection system 56. In the illustrated embodiment, deflection system 56 comprises a two-axis optical scanner 60 and a scan lens 62. Scan lens 62 focuses light from light source 52 to point 65. Optical scanner 60 can be operated to vary the location of point 65 in two-dimensions.

The location (x, y) of point 65 determines the angle (φ, θ) at which light exits condenser lens 66. A beam 68 of light passes through specimen S and is imaged by an objective lens 69 onto a light detector 70.

Light source 52 preferably generates a highly collimated light beam. Light source 52 may comprise a laser, for example. Other sources, such as light emitting diodes (LEDs), arc lamps, or tungsten-halogen lamps, may also be used. These alternative light sources may provide decreased optical efficiency and signal-to-noise ratio in comparison to systems in which a laser light source is used. Where light source 52 is a laser, a rotating diffuser (not shown) may be provided to reduce speckle in the images due to coherence effects.

Light detector 70 may comprise a 1-dimensional or 2-dimensional array of light sensors. For example, light detector 70 may comprise:
a CCD array,
an active pixel sensor array,
a charge injection device,
a CMOS light detector array, or
another light detector capable of obtaining a one- or two-dimensional projection, as required, of specimen S.
   In some embodiments, light detector 70 is provided by a digital camera or a video camera.

Condenser lens 66 and objective lens 69 are preferably high numerical aperture lenses. These lenses preferably have numerical apertures of at least 0.9. In some embodiments, lenses 66 and 69 have numerical apertures in the range of 1 to 1.4.

Optical scanner 60 may scan in one or two dimensions. For 1-D scanning, optical scanner 60 may comprise a mirror, prism, or other light deflector that can be tipped or rotated by a suitable actuator. For example, optical scanner 60 may comprise:
a mirror on a (1-D) tip-stage;
a mirror on 1-D galvanometer movement;
a prism such as a roof-prism, 90°-prism, or the like mounted to a translational or rotational stage; or
another suitable light deflector.
   The motion of optical scanner 60 may be controlled by any suitable computer-controlled actuator 71. For example, the actuator may comprise:
a piezoelectric actuator;
a stepper motor;
a servo motor;
a linear motor; or
other suitable actuator.

For 2-D scanning, optical scanner 60 may comprise two 1-D optical scanners arranged so as to deflect point 65 in different directions on pupil plane 64 or a 2-D optical scanner such as:
a two-axis galvanometer;
a mirror on a tip-tilt (2-D) stage; or
some other suitable 2-D optical scanner.
   actuated by a suitable actuator 71.

Microscope 50 may comprise a controller 72 that controls optical scanner 60 to move point 65 to a series of positions, each corresponding to a desired angle of illumination of specimen S. Controller 72 can then operate light detector 70 to acquire a projection of the specimen S at the angle of illumination. Controller 72 may comprise a programmable data processor executing suitable software or firmware instructions, a hard-wired control system or any suitable combination thereof.

As those who are skilled in the art will appreciate, projections will need to be (a) corrected for intensity because the flux received by a volume element of the specimen will depend, in general, on the angle of illumination, and; (b) spatially stretched to compensate for any linear projection-distortion introduced by the objective lens.

The projections may be processed by any suitable computed-tomography reconstruction method to yield a 2-D or 3-D image of specimen S. The reconstruction method may be a transform-based method, an iterative reconstruction method, or a suitable combination thereof. A particular method for image reconstruction which is considered advantageous is described below.

Controller 72 optionally performs an image reconstruction method. If so, a display 74 may be connected to controller 72 to permit a user to view the reconstructed image. Display 74 may also be part of a user interface (not shown) by way of which a user can control the operation of controller 72.

A prototype microscope having the general construction shown in FIG. 2A has been made. The prototype microscope is based on a conventional transmission microscope in which the sub-stage condenser has been replaced with a second objective lens mounted on an independent translation stage.

It can be appreciated that microscope 50 has some significant advantages over the prior art microscope 10 shown in FIG. 1. These include:
The optical efficiency is increased greatly since most of the incident light is used.
The signal-noise ratio is also better.
The entire angular view of the system defined by the numerical aperture (NA) of the objective lens can be used.

FIG. 2B shows a microscope 75 according to an alternative embodiment of the invention. In FIG. 2B, elements that are also shown in FIG. 2A are identified by the same reference numerals as are used in FIG. 2A. Microscope 75 is similar to microscope 50 of FIG. 2A with the exception that it includes an optical system 76 on a detection-side of specimen S that can selectively pass light from beam 68 to light sensor 70 while rejecting scattered light rays that are propagating in directions different from the direction of beam 68.

Optical system 76 rejects at least most scattered light 77 that is scattered in directions different from the direction of beam 68.

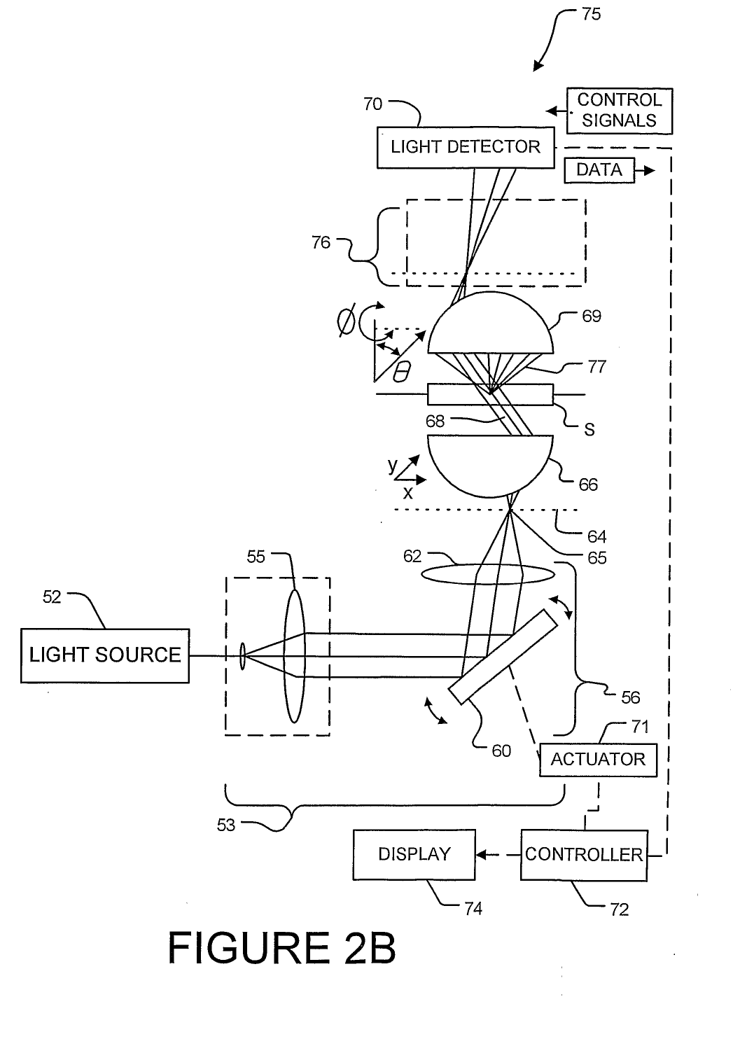

Optical system 76 may take various forms. For example optical system 76 may comprise:
A pinhole 77 in pupil plane 78 of objective lens 69 and an actuator system controlled by a suitable controller, such as controller 72, capable of moving pinhole 77 to a location corresponding to beam 68 (See FIG. 3A).
A spatial light modulator 80 either of a reflective type (such as a DMD) or, as illustrated, a transmission-type spatial modulator located in pupil plane 78 of objective lens 69 or a plane conjugate to pupil plane 78 and a controller (such as controller 72) configured to turn on a spot-like area 81 of the spatial light modulator corresponding to the location 82 at which light from beam 68 will be focused by objective lens 69 (see FIG. 3B).
A second optical scanner 84 arranged in a suitable optical system which can be controlled to direct light from the location 82 at which light from beam 68 will be focused by objective lens 69 onto light detector 70 (see FIG. 3C).

FIG. 2C shows a microscope 85 according to an alternative embodiment of the invention. In FIG. 2C, elements that are also shown in FIG. 2A are identified by the same reference numerals as are used in FIG. 2A. Microscope 85 differs from microscope 50 in that it lacks an illumination-side optical scanner 60 (see FIG. 2A) but has an optical scanner 88 on the detection side of objective lens 69.

Optical scanner 88 functions in combination with a detection-side optical system 89 to selectively direct light from the location at which light from beam 68 will be focused on pupil plane 78 by objective lens 69 onto light detector 70.

Microscopes according to some embodiments of the invention may include a variable-wavelength light source or a set of light sources that produce light of different wavelengths. In such embodiments, a set of projections may be obtained for each of a plurality of different wavelengths. The plural sets of projections may be processed to provide a reconstructed 2-D or 3-D image of the specimen in color.

Color images of a specimen S may be obtained by obtaining a set of projected images for each of two or more different wavelengths. This may be done by any of:
providing a polychromatic light source 52, providing one or more filters in the optical path, and changing the filters for each set of projections;
providing a tunable light source, such as a dye laser, and operating the light source to produce radiation of a different wavelength for each set of projections; or
providing a plurality of different light sources, such as a set of lasers, each light source generating radiation of a different wavelength and using a different one of the light sources to acquire each set of the projections.

For example, to obtain true-color (RGB) 3-D images, three 3-D images of the specimen can be reconstructed separately from three sets of projections. Each set of projections is taken with illumination light of a different wavelength (e.g. red, green, and blue spectra). The three 3-D images can then be combined to yield one 3-D RGB image.

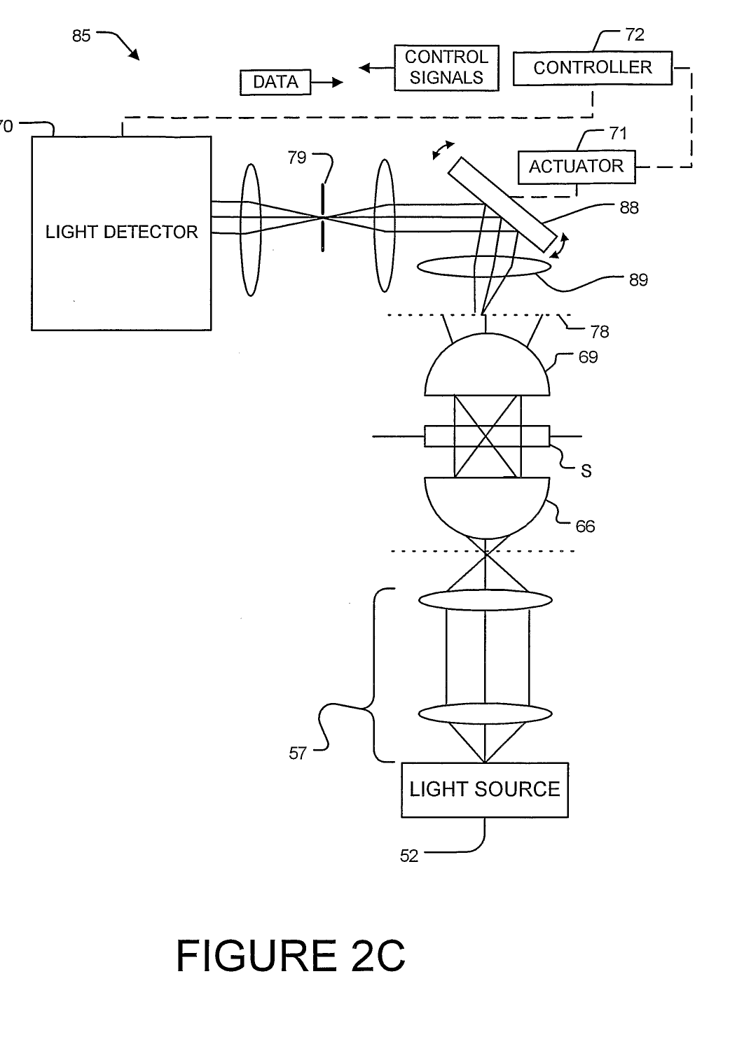

FIG. 4 shows schematically an optical scanner-based computed-tomography microscope 90 having three collimated light sources 52R, 52G and 52B. Microscope 90 includes mirrors 72A, 72B and 72C that can be configured to pass light from any one of light sources 52R, 52G and 52B to beam expander 55. Microscope 90 is otherwise constructed in the same manner as microscope 50 of FIG. 2A. As described above, for more efficiency, light from each light source 52 is preferably highly collimated (for example, the light may comprise a highly collimated laser beam).

Microscopes as described herein have a wide range of applications. An example applications is 3-D visualization and quantitative analysis of absorption-stained fixed pathological material at the cellular level, such as required for early detection and diagnosis of cancer. 3-D images and quantitative total DNA amount (ploidy) data provide pathologists with valuable information for medical diagnosis. The prototype optical computed-tomography microscope developed by the inventors (i) enables viewing multiple optical levels of a section; (ii) removes sectioning artifacts by increasing the thickness of tissue sections; (iii) shows natural tissue architecture, including whole intact cells, (iv) enables quantitative measurement of ploidy information, and (v) provides a cost-effective alternative to confocal microscopes.

The prototype has been used, for example, to generate 3-D volume reconstructions of quantitatively absorption-stained cervical cells and Feulgen-Thionin stained thick tissue specimens. In some embodiments, the tissue specimens have had thicknesses in the range of 4 μm to 30 μm.

Once a 3-D image of a specimen has been generated then standard image manipulation techniques may be used to generate 3-D rotations, Z-stack image sequences, Y-stack image sequences or other visualizations which can help users to understand the 3-D structure of the specimen being studied.

In addition to being provided as a complete microscopy system, the invention may be implemented in the form of an accessory for an existing microscope. The accessory can be added to an existing microscope to provide a microscope system as described herein.

Image Reconstruction

One difficulty with the systems shown in FIGS. 1 to 4 is that the range of angles in which it is possible to direct light through a specimen is limited by the numerical apertures of condenser lens 66 and objective lens 69. The measured projections can be taken only within an angle range that is significantly less than 180 degrees. In such apparatus it is typically impractical to obtain projections of a specimen for all angles. Depending upon the numerical apertures of lenses 66 and 69, the available angles may be, for example, in the range of 90 degrees to 135 degrees. That is, the angles of the available projections all lie within a conical surface having a half-angle of 70 degrees or less and, in some embodiments, 50 degrees or less. This may result in artifacts if conventional computed-tomography methods are used to reconstruct 2-D or 3-D images from the limited range of projections that such apparatus can provide.

The limited-angle problem also arises in other applications of computed tomography. For example, this problem arises in the fields of:
optical computed tomography (see R. Chamgoulov, et al. Optical computed-tomography microscope for three-dimensional quantitative histology, Cellular Oncology, 2004 and R. Chamgoulov et al. Limited-angle reconstruction algorithms in computed-tomography microscopic imaging, Medical Imaging 2005: Image Processing, Proc. of SPIE, vol. 5747, pp. 2163-2170, 2005);
microtomography (see G. Levin et al., Three-dimensional limited-angle microtomography of blood cells: experimental results, Proc. SPIE, vol. 3261, 1998, pp. 159-164);
geophysical studies (see H. Frey et al., Tomographic methods for magnetospheric applications, in Science closure and enabling technologies for constellation class missions, eds. V. Angelopoulos and P. Panetta, University of California, 1998, pp. 72-77);
physical science applications (see D. Verhoeven Limited-data computed tomography algorithms for the physical sciences, Applied Optics, vol. 32, No. 20, 1993, pp. 3736-3754); and,
engineering applications (see J. Boyd, Limited-angle computed tomography for sandwich structures using data fusion, Journal of Nondestructive Evaluation, Vol. 14, No. 2, 1995, p 61-76).

A method for reconstructing images from projections will now be described. The method has particular advantage where the projections are from a limited range of angles. The method may be applied to reconstruct images from projections taken by microscopes as described above or to reconstruct images in other computed-tomography applications, including limited-angle or other limited-data applications. The method uses feedback iteratively to correct an image. The method may be applied for two-dimensional or three-dimensional image reconstruction.

The method endeavors to obtain a reconstructed image that matches closely the measured projections. The method involves applying a suitable transformation to the projections to obtain a reconstructed image of a specimen. Any suitable transform may be used. The reconstructed image is then refined by generating an error image from differences between the measured, initial, projections and projections taken from the reconstructed image. The reconstructed image and error image are then combined to provide a refined reconstructed image. In some embodiments, combining the reconstructed image with the error image comprises multiplying the error image by a suitable feedback gain factor and adding the result to the reconstructed image. The steps of refining the reconstructed image may be iterated until a final refined image is obtained.

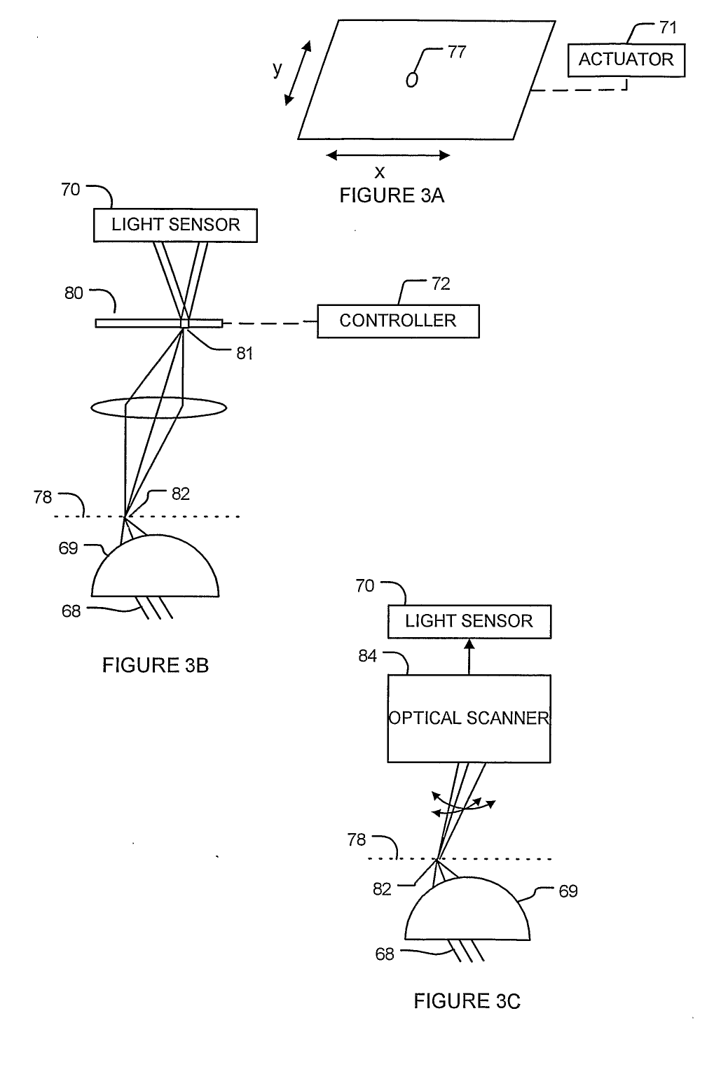

FIG. 5 shows a method 100 according to an embodiment of the invention. Method 100 begins at block 104 by acquiring a set 106 of projections 107 of a specimen S. Each projection 107 of set 106 is a 1-D or 2-D image generated when a beam of radiation is directed through specimen S at a particular angle. Set 106 of projections 107 may include a number of projections corresponding to angles within certain angular ranges and may lack projections corresponding to angles within other angular ranges.

At block 108 an initial image is obtained. The initial image may be obtained in any suitable way. For example, the initial image may be obtained by way of a statistical method, an algebraic reconstruction method, a transform-based reconstruction method, an estimate of the density of the specimen based upon a priori knowledge of the specimen or any other suitable way. In the illustrated embodiment, block 108 involves applying the set 106 of projections 107 as input to a reconstruction transform. The reconstruction transform may comprise any suitable tomographic reconstruction transformation. for example, block 108 may comprise performing on the initial projections 107:
a FBP algorithm;
an inverse Radon transformation;
an inverse Hartley transformation; or,
another suitable transformation.
   As noted above, the initial image is not necessarily obtained by way of a transformation. The reconstruction transform need not be particularly accurate. It is desirable to avoid non-linearities in the implementation of the reconstruction transformation (e.g., interpolation to nearest, etc). Block 108 yields a reconstructed image 112. Reconstructed image 112 is a 2-D or 3-D model of the density of specimen S.

Block 114 calculates what projections would result if beams of radiation were sent through reconstructed image 112 at the same angles as the angles corresponding to initial projections 107. This yields a set 116 of estimated projections 117. Estimated projections 117 may be obtained, for example, by applying the inverse of the transformation used in block 108. Each estimated projection 117 corresponds to an initial projection 107.

Block 120 computes differences between projections 107 and estimated projections 117. In general, projections 117 will differ from projections 107. Projections 117 may differ from projections 107, in part, as a result of any filtering performed by the reconstruction function. Typically the reconstruction function includes a low-frequency filter such as a Ram-Lack filter, a Hemming, filter etc). Differences between estimated projections 117 and projections 107 may also arise where projections 107 do not span a full range of angles.

Method 100 performs feedback correction based on the differences 119 between estimated projections 117 and projections 107. The feedback on the error of projection may be calculated from the differences between initial projections 107 and the corresponding estimated projections 117 obtained from the reconstructed image on the current (e.g. k^{th}) iteration.

In block 130 the “projection error” determined in block 120 is used to reconstruct an “error image” 127. The error image may be created by using the projection error as an input to the reconstruction function. The error image is a 2-D or 3-D image.

In block 140 error image 127 is combined with the reconstructed image obtained from the previous iteration with a feedback gain factor.

The reconstructed image should always have a physical meaning. For example the optical density of an object cannot be negative. In cases where a reconstructed image includes points having a negative density, it can be desirable to replace the negative density with a density of zero or a very small value.

Loop 150 comprising blocks 114, 120, 130 and 140 is iterated repeated until a termination condition is satisfied. In each iteration, the reconstructed image from the previous iteration is refined. The termination condition may comprise a desired precision being obtained, or a desired number of iterations have been completed or the like.

A formula that can be used to obtain a refined reconstructed image in each iteration of combine the error image with the reconstructed image is:
Îₖ₊₁=Îₖ+μR⁻¹(P−R(Îₖ)) (1)
where Îₖ and Îₖ₊₁ are images on the k^{th and} (k+1)^{th} iterations respectively; μ is a feedback gain factor; the operators R and R⁻¹ represent direct and inverse projection operators (e.g., Radon transformation and inverse Radon transformation operators) respectively; and, P denotes the set 110 of initial projections 107.

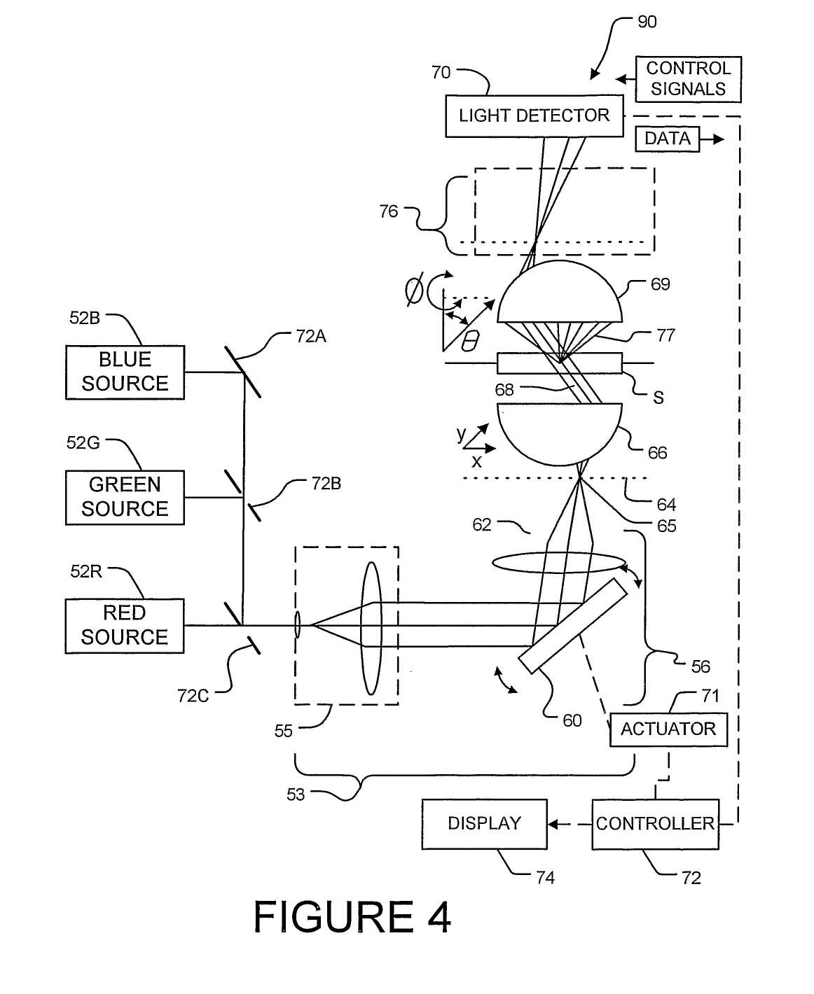

Method 100 is sensitive to the value of the feedback gain factor (or “step size”) μ. Reconstruction results for 120-degree projection data with different values of μ are shown in FIG. 6.

If the data in the initial projections is less than the number of unknowns in the reconstruction transformation of block 108, then more than one solution exists. In such cases, performing low-pass filtering (LPF) as part of the reconstruction transformation can effectively reduce the number of independent variables. LPF may optionally be applied to the right-hand side of Equation (1).

The closer the estimated projections 117 of the reconstructed image are to the original projections 107, the closer is the reconstructed image to specimen S. According to Equation (1), the reconstructed image correction can potentially achieve any desirable precision. In practice computation effects limit the precision.

Method 100 has been compared to the standard filtered back-projection algorithm for the task of reconstructing a 2-D image from 120 projections taken uniformly within 120 degrees. The image reconstructed by the filtered back-projection algorithm had various defects including:
Large areas in the reconstructed image, which should have had uniform density, were not uniform;
The transitions at sharp changes of density are recovered with high-frequency spikes, like sharpening halos;
Due to the use of a low-frequency filter, the resolution is poor. Small details at the center of the image are not reproduced.

By contrast, when method 100 was used to reconstruct an image from the same initial projections, after 20 iterations all three problems which were evident in the image obtained by filtered back-projections were significantly less prominent. The areas with uniform density were reconstructed more uniformly, density transitions more closely matched those of the original, and small details in the center of the reconstructed image were reproduced more clearly.

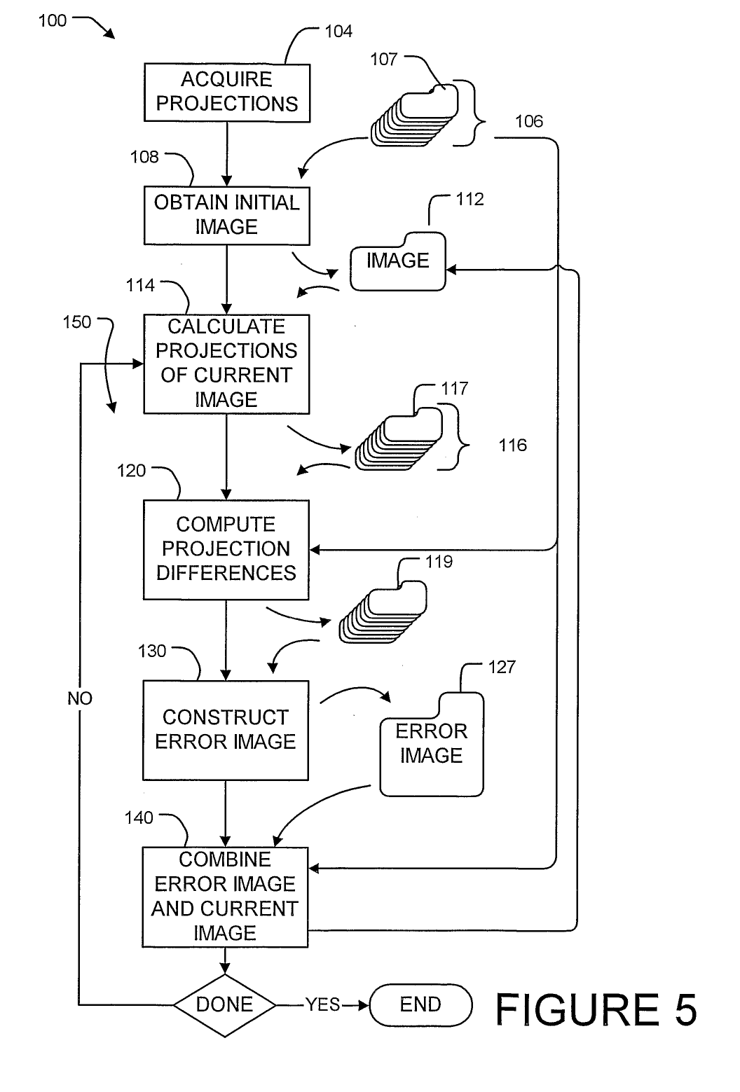

FIG. 7A shows the projection error (i.e. the difference between projections of an image reconstructed by the FBP algorithm and the initial projections). This projection error is typical of the projection error that might be present in a reconstructed image produced in block 108 of method 100. By comparison, FIG. 7B shows the projection error of a refined reconstructed image after the 20^{th} iteration of loop 150 in method 100. The absolute value of the projection error in FIG. 7B is approximately a factor of 8 less than the projection error of FIG. 7A.

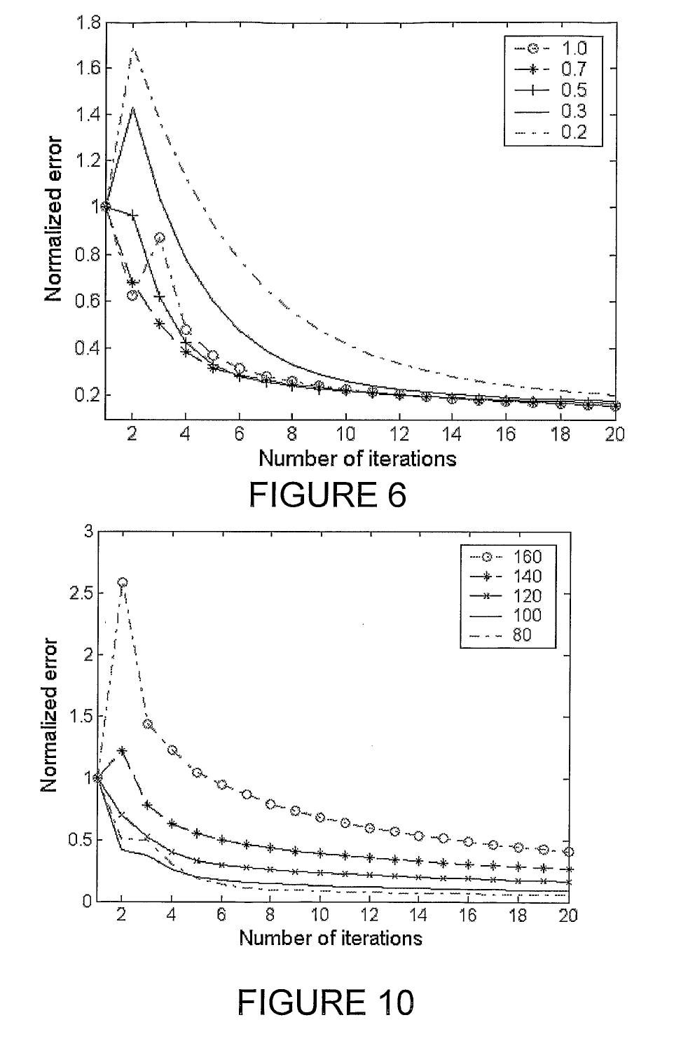

One possible measure of projection error is the square root of the sum of the squares of the difference between the initial projections and projections of the reconstructed image for each pixel in the reconstructed image. FIG. 8 shows how projection error for the limited-angle (120 degrees) reconstruction drops as loop 150 is iterated. In FIG. 8, the error is normalized to the error value present in the first iteration. It can be seen that, in this example, the projection error drops quickly. After only three iterations it decreases by more than a factor of 2. After 20 iterations it decreases about 8-fold.

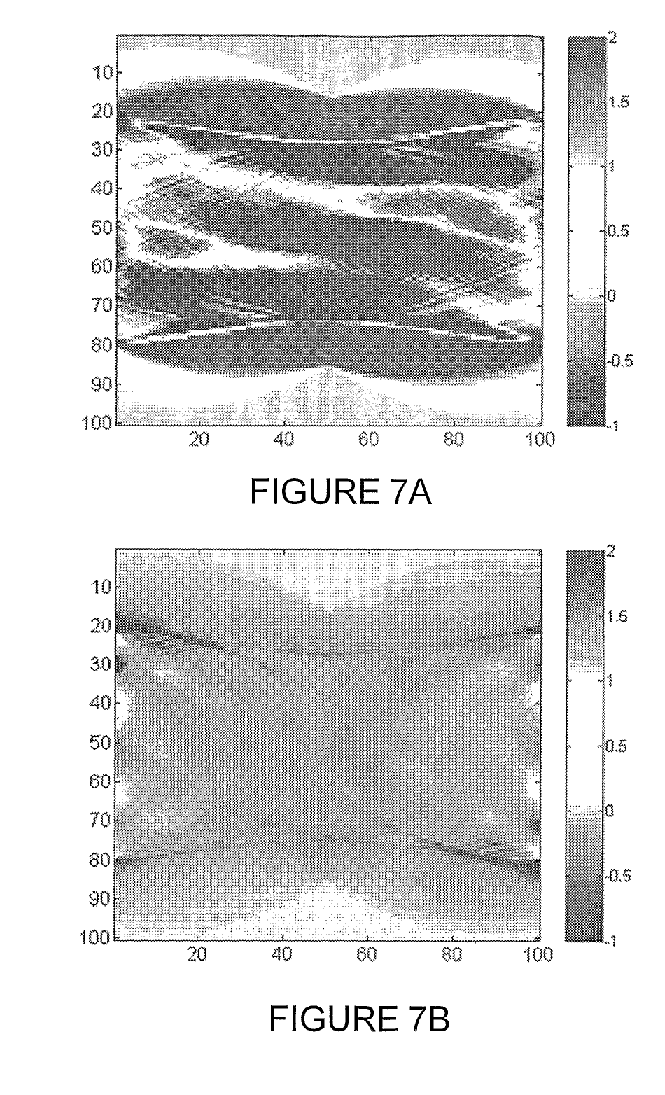

The results of application of method 100 in a case where an image must be reconstructed from a limited number of projections are presented in FIG. 9. The normalized error versus the number of iterations is shown for different numbers of initial projections (200, 100, 50, 40, and 30 projections).

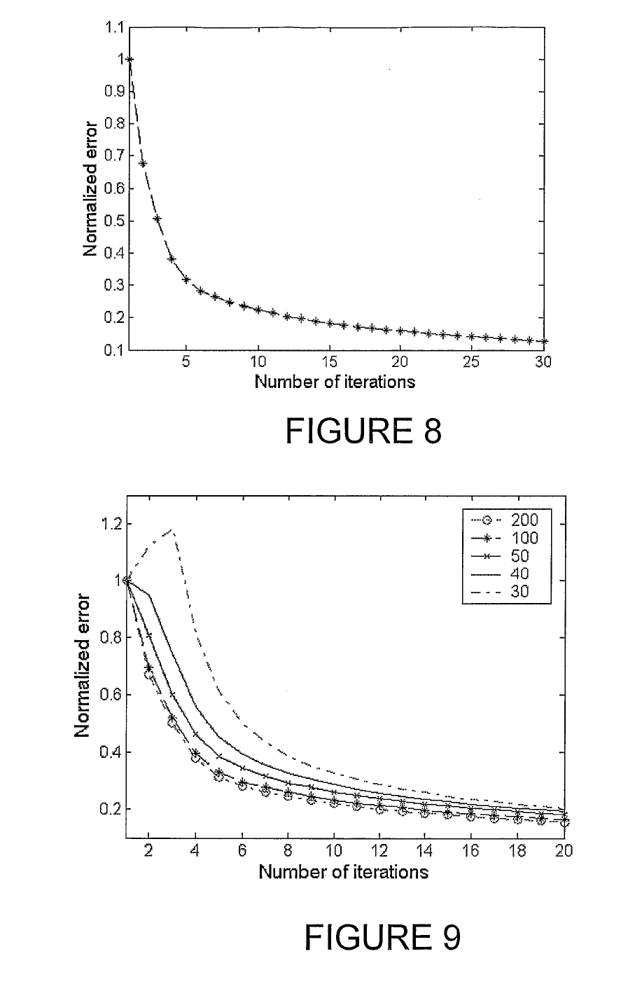

FIG. 10 illustrates the application of method 100 to different limited-angles reconstructions (from 160 to 80 degrees). It can be seen that for very limited angles (below 120 degrees) the accuracy of the reconstructed image is improved many times in a few iterations.

It can be seen that method 100 combines virtues of transform-based and iterative reconstruction techniques. It is optionally possible to incorporate previously-known information about specimen S. For example, prior knowledge such as dimensional information about specimen S, a range of densities in the specimen, background values of the specimen, and so forth can be taken into account on each iteration step. This can improve the accuracy of the final reconstruction or reduce the number of iterations required to achieve an acceptable reconstructed image of the specimen.

Convergence Analysis

It can be shown that method 100 can be implemented in a way that is stable. As long as the feedback in method 100 is negative and the maximum eigenvalues of the transformation used to reconstruct the error image are less than 1.0, the stability of the method is ensured. From the computational point of view, the pair R⁻¹(R(.)) should be sufficiently close to the unity transform.

On the other hand, a method that implements Equation (1) may diverge if not implemented carefully. Method 100, like any method using feedback on error, can be adversely affected by deviations from “paper formulas”, error accumulation phenomena, and other effects that can trigger feedback loop destabilization. Those skilled in the art will understand how to select parameter values and computational algorithms to implement Equation (1) or to otherwise implement method 100 in a way that will converge to a refined reconstructed image.

It is known that the Radon transformation operator R is linear:
R(Î)−R(Îₖ)=R(Î−Îₖ) (3)

Initial projection set P is a measured linear integral from the original object and in general includes a noise component (measurement error) η:
P=R(Î)+η (4)
Taking into account (2) and (3), after subtracting the original image from (1) we derive the error equation:
δₖ₊₁=δₖ−μR⁻¹(R(δ))+μR⁻¹(η) (5)
Here, δₖ₊₁ is the difference between the image reconstructed on the k-th iteration and the original image. δₖ₊₁ is given by:
δₖ₊₁=[1−μR⁻¹R]δₖ+μR⁻¹(η) (6)
Where 1 denotes the unitary matrix.

The size of the component μR⁻¹(η) in equation (5) determines the limit of calculation accuracy.

We want to estimate the covariation matrix of the calculation errors:
Dₖ=E(δₖδₖ^{T}) (7)
Where E( ) denotes the operator of mathematical expectation, δₖ^{T} denotes the transposed matrix of the calculation error.

Assuming that projections are measured without errors the covariation matrix can be expressed as:
Dₖ₊₁=Dₖ(1−μR⁻¹R)Dₖ(1−μR⁻¹R)^{T} (8)

The eigenvalue spectra of matrix M=(1−μR⁻¹R) in equation (7) uniquely determines a convergence of the method. For the method to converge it is necessary and sufficient that all eigenvalues are distributed within the interval [−1:1]. In this case matrix M is a space compression operator. The closer the eigenvalues of matrix M are to zero, the faster the method converges.

If we have projections of a specimen from a set of angles within 360 degrees and the number of measured line integrals (i.e. the number of pixels in projections 107) is more than the number of pixels (or voxels) in the image, then the operator R⁻¹R will be close to the unity transform 1. In this case, matrix M will be close to the zero matrix if parameter μ=1.

Generally the operator R⁻¹R is a matrix of non-complete class since the number of measured line integrals in practice is usually less than the number of pixels (or voxels) in the image. The eigenvalues of the R⁻¹R operator can fluctuate (with the values close to zero) because of calculation effects. Those calculation effects depend on the algorithm chosen to calculate the R⁻¹ transformation and arise mostly from interpolation and filtering procedures. In particular, filtering high frequencies during computation of R⁻¹ has unfavorable effects on convergence. Using smooth interpolation algorithms improves the situation. Interpolation “to nearest” is preferably avoided since it results in non-linearity. Negative eigenvalues of the R⁻¹R operator that could arise from calculation effects can lead to divergence. The parameters of the R⁻¹ transformation and the value of the feedback parameter μ should be selected so that convergence is guaranteed.

Matrix M is well determined for typical applications of method 100. In such cases, method 100 converges quickly and provides an accurate refined reconstructed image.

Certain implementations of the invention comprise data processors which execute software instructions which cause the processors to perform a method of the invention. The invention may also be provided in the form of a program product. The program product may comprise any medium which carries a set of computer-readable signals comprising instructions which, when executed by a data processor, cause the data processor to execute a method of the invention. The program product may be in any of a wide variety of forms. The program product may comprise, for example, physical media such as magnetic data storage media including floppy diskettes, hard disk drives, optical data storage media including CD ROMs, DVDs, electronic data storage media including ROMs, flash RAM, or the like or transmission-type media such as digital or analog communication links.

Where a component (e.g. a software module, processor, assembly, device, circuit, etc.) is referred to above, unless otherwise indicated, reference to that component (including a reference to a “means”) should be interpreted as including as equivalents of that component any component which performs the function of the described component (i.e., that is functionally equivalent), including components which are not structurally equivalent to the disclosed structure which performs the function in the illustrated exemplary embodiments of the invention.

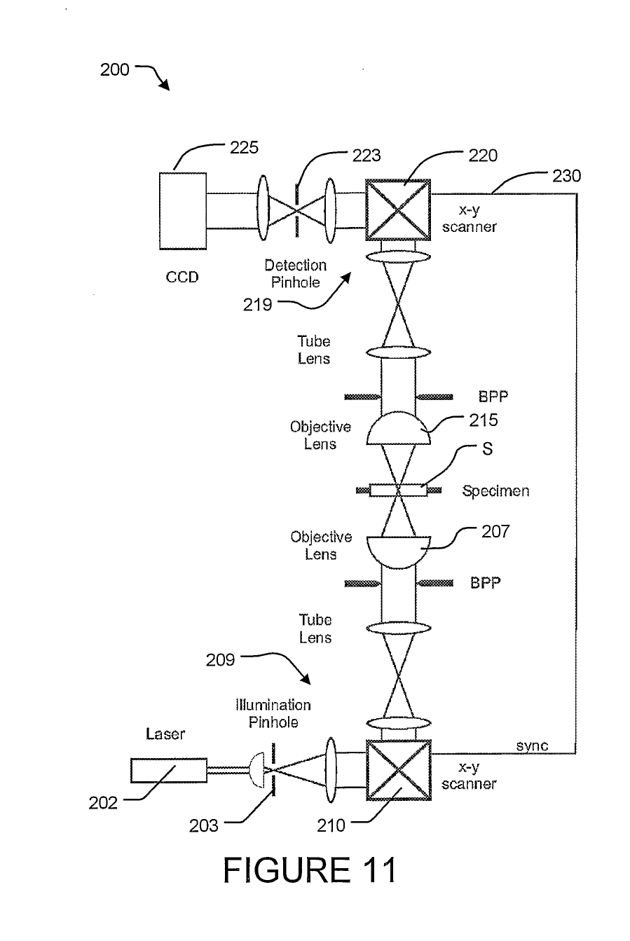

While a number of exemplary aspects and embodiments have been discussed above, those of skill in the art will recognize certain modifications, permutations, additions and sub-combinations thereof. For example:
A microscope according to the invention may visualize bright field or darkfield images or alternating light and darkfield images.
In the reconstruction methods described above, the initial reconstructed image of a specimen may be based on fewer than all of the projections used to refine the reconstructed image. In a minimal case, the initial reconstructed image may be based upon one or more projections of the specimen, a priori knowledge of the specimen, or both one or more projections of the specimen and a priori knowledge of the specimen. For example, if the specimen is a slab of known thickness then the initial reconstructed image may be set to be an image having an average density within the known boundaries of the slab and zero density outside of the slab. Where the initial reconstructed image is of poor quality (i.e. is a poor match to the specimen) then the method will converge more slowly to an acceptable reconstructed image than it would if the initial reconstructed image is of good quality.
In one preferred embodiment, the optical computed-tomography microscope is a confocal microscope. FIG. 11 shows an example confocal microscope 200. Microscope 200 has a light source such as a laser 202. Light from laser 202 is focused through illumination pinhole 203 from where the light is passed to an objective lens 207 by an optical system 209 that includes an X—Y scanner 210. The light passes through a specimen S to an objective lens 215. A second optical system 219 that includes a second X—Y scanner 220 focuses the light through a detector pin hole 223 into a light sensor 225. The operation of X—Y scanners 210 and 220 is coordinated by SYNC signal 230.
   It is therefore intended that the following appended claims and claims hereafter introduced are interpreted to include all such modifications, permutations, additions and sub-combinations as are within their true spirit and scope.

1. A computed-tomography microscope comprising:
a light source;
a condenser lens having a pupil plane;
an objective lens located to collect light incident from the condenser lens and deliver the collected light to a light sensor;
a support for holding a specimen between the condenser lens and the objective lens; and
an optical system comprising an optical scanner operable to cause light passing through the specimen at an angle corresponding to a setting of the optical scanner to be selectively detected at the light sensor.

2. A computed-tomography microscope according to claim 1 wherein the optical system is arranged to focus light from the light source at a focal point on the pupil plane of the condenser lens and the optical scanner is operable to move a location of the focal point on the pupil plane.

3. A computed-tomography microscope according to claim 2 wherein substantially all light emitted by the light source into the optical system is focused at the focal point.

4. A computed-tomography microscope according to claim 2 wherein the optical system comprises a detection-side light selector operative to selectively direct light from an area on a pupil plane of the objective lens corresponding to the focal point to the light sensor.

5. A computed-tomography microscope according to claim 4 wherein the detection-side light selector comprises a second optical scanner and a controller operative to orient the second optical scanner to direct light from the area on the pupil plane of the objective lens to the light sensor.

6. A computed-tomography microscope according to claim 4 wherein the detection-side light selector comprises a DMD and a controller operative to turn on pixels of the DMD corresponding to the area on the pupil plane of the objective lens.

7. A computed-tomography microscope according to claim 4 wherein the detection-side light selector comprises a pinhole and a mechanism for moving the pinhole to the area on the pupil plane of the objective lens.

8. A computed-tomography microscope according to claim 1 wherein the optical scanner comprises a two-axis optical scanner.

9. A computed-tomography microscope according to claim 1 wherein the optical scanner comprises a movable prism.

10. A computed-tomography microscope according to claim 1 wherein the optical scanner comprises a tilting mirror.

11. A computed-tomography microscope according to claim 1 wherein the optical system comprises a scan lens having a focal point on the pupil plane of the condenser lens.

12. (canceled)

13. A computed-tomography microscope according to claim 11 wherein the optical system comprises a beam expander and the optical scanner is located in an optical path between the beam expander and the scan lens.

14. A computed-tomography microscope according to claim 1 wherein the light source comprises a source of collimated light.

15. A computed-tomography microscope according to claim 1 wherein the light source is substantially monochromatic.

16. A computed-tomography microscope according to claim 14 wherein the light source comprises a laser.

17. A computed-tomography microscope according to claim 1 comprising a plurality of light sources, each of the plurality of light sources having different spectral characteristics.

18.-19. (canceled)

20. A computed-tomography microscope according to claim 17 wherein the plurality of light sources comprise a plurality of lasers, each of the lasers operating at a different wavelength.

21. A computed-tomography microscope according to claim 20 wherein the plurality of lasers include lasers emitting one or more of red green and blue light.

22. A computed-tomography microscope according to claim 1 wherein a wavelength of light emitted by the light source is adjustable.

23. (canceled)

24. A computed-tomography microscope according to claim 1 wherein the light sensor comprises an array of light detectors.

25.-28. (canceled)

29. A computed-tomography microscope according to claim 1 wherein the light sensor comprises a light detector and a variable optical system configured to sequentially direct light from different areas of a projection of the specimen onto the light detector.

30. (canceled)

31. A computed-tomography microscope according to claim 1 wherein the condenser and objective lenses each have a numerical aperture of at least 1.0.

32. A computed-tomography microscope according to claim 1 wherein the optical system is arranged to collect light at a focal point on a pupil plane of the objective lens and direct the light to the light sensor and the optical scanner is operable to move a location of the focal point on the pupil plane of the objective lens.

33. A computed-tomography microscope according to claim 1 comprising a controller connected to the optical scanner, the controller configured to:
for each of a plurality of angles, adjust the optical scanner to cause light passing through the specimen at the angle to be selectively detected at the light sensor and operate the light sensor to acquire an initial projection of the specimen corresponding to the angle.

34. A computed-tomography microscope according to claim 33 wherein the angles all lie within a conical surface having a half-angle of 70 degrees or less.

35. (canceled)

36. A computed-tomography microscope according to claim 33 comprising a data processor and software instructions to cause the data processor to process the projections to yield an image of the specimen by the steps of:
obtaining a reconstructed image of the specimen; and,
iteratively refining the reconstructed image of the specimen by performing a plurality of times:
for each of the plurality of angles computing a computed projection of the reconstructed image and computing a difference between the computed projection and the corresponding initial projection;
applying the transform to the computed differences to yield an error image; and,
combining the error image with the reconstructed image.

37. A computed-tomography microscope according to claim 36 wherein the software instructions cause the data processor to obtain the reconstructed image of the specimen by applying a transform to the initial projections.

38. A computed-tomography microscope comprising:
a light source;
a condenser lens having a pupil plane;
an optical system arranged to focus light from the light source at a focal point on the pupil plane of the condenser lens, the optical system comprising an optical scanner operable to move a location of the focal point on the pupil plane;
an objective lens located to collect light incident from the condenser lens and deliver the collected light to a light sensor; and,
a support for holding a specimen between the condenser lens and the objective lens.

39. A method for generating a image of a specimen, the method comprising:
for each of a plurality of angles, obtaining an initial projection of the specimen;
obtaining a reconstructed image of the specimen;
refining the reconstructed image of the specimen by:
for each of the plurality of angles computing a computed projection of the reconstructed image and computing a difference between the computed projection and the corresponding initial projection;
applying a transform to the computed differences to yield an error image; and,
combining the error image with the reconstructed image.

40. A method according to claim 39 wherein obtaining the reconstructed image of the specimen comprises applying an initial transform to the initial projections.

41. A method according to claim 40 wherein the initial transform and the transform used to yield the error image are substantially the same transform.

42. A method according to claim 39 comprising iterating refining the reconstructed image a plurality of times.

43.-45. (canceled)

46. A method according to claim 39 wherein the reconstructed image is a 3-D image and each initial projection is a 2-D image.

47. A method according to claim 39 wherein the reconstructed image is a 2-D image and each initial projection is a 1-D image.

48. A method according to claim 39 wherein applying the transform comprises applying an inverse Radon transform.

49. A method according to claim 39 wherein applying the transform comprises applying an inverse Hartley transform.

50. A method according to claim 39 wherein applying the transform comprises applying a low frequency filter.

51. A method according to claim 39 wherein applying the transform comprises performing a filtered back projection.

52. A method according to claim 39 wherein refining the reconstructed image comprises determining if any point in the reconstructed image has a negative value and, if so, setting a value of the point in the reconstructed image to zero.

53. A method according to claim 39 wherein obtaining the projection of the specimen comprises directing a beam of radiation through the specimen at the angle onto an imaging array.

54.-57. (canceled)

58. A method according to claim 39 wherein all of the angles lie within a conical surface having a half-angle of 70 degrees or less.

59. (canceled)

60. (canceled)
